(19) United States
(12) Patent Application Publication
(10) Pub. No.: US 2015/0346763 A1
(43) Pub. Date: Dec. 3, 2015

(54) APPARATUS MANAGEMENT DEVICE, CLOCK SPEED CONTROL METHOD, AND PROGRAM

(71) Applicants: Noriyuki KOMIYA, (US); Taichi ISHIZAKA, (US); Shigeki SUZUKI, (US); Takahiro ITO, (US); Takeru KUROIWA, (US)

(72) Inventors: Noriyuki KOMIYA, Tokyo (JP); Taichi ISHIZAKA, Tokyo (JP); Shigeki SUZUKI, Tokyo (JP); Takahiro ITO, Tokyo (JP); Takeru KUROIWA, Tokyo (JP)

(73) Assignee: Mitsubishi Electric Corporation, Tokyo (JP)

(21) Appl. No.: 14/760,761

(22) PCT Filed: Feb. 13, 2013
(86) PCT No.: PCT/JP2013/053375

§ 371 Date: Jul. 14, 2015

(51) Int. Cl. G06F 1/14; G06N 99/00

(52) U.S. Cl. CPC G06F 1/14; G06N 99/005

(57) ABSTRACT

An apparatus manager monitors and controls respective apparatus connected via a network. A learner learns load periods when a significant load is imposed on a processor, on the basis of a utilization condition of the processor, and stores load period information indicating the learned load periods in auxiliary storage. The clock speed controller references the load period information, and controls the operating clock speed of the processor to be a normal level clock speed if the current time is during a load period, and a low level clock speed if the current time is during a time period other than a load period.

### TECHNICAL FIELD

The present disclosure relates to an apparatus management device, a clock speed control method, and a program that manages apparatus such as air conditioners and lighting equipment connected via a network.

### BACKGROUND ART

A device such as an embedded apparatus or a personal computer (PC) equipped with a microprocessor (hereinafter, processor) may be used to monitor the state of apparatus such as air conditioners and lighting equipment, and control operation.

With such a device, processor thermal dissipation and energy efficiency are issues. There exists known technology for moderating processor thermal output and reducing power consumption, in which the operating clock speed of the processor is lowered when the temperature of the processor becomes equal to or greater than a designated value. However, the drop in processing performance due to lowering the operating clock speed is a problem.

Patent Literature 1 describes technology that prevents a drop in the processing performance of a processor. A managed device in the system described in Patent Literature 1 is equipped with an auxiliary processor separate from the main processor. Additionally, a management device of the system lowers the operating clock speed when the temperature of the main processor exceeds a threshold value. Additionally, when the processing performance of the main processor has dropped in the state of lowered operating clock speed, the management device dynamically adds the auxiliary processor to prevent a drop in processing performance.

### CITATION LIST

### Patent Literature

Patent Literature 1: Unexamined Japanese Patent Application Kokai Publication No. 2010-97257

### SUMMARY OF INVENTION

### Technical Problem

In the system described in Patent Literature 1, since the managed device requires an auxiliary processor in addition to a main processor, there is the problem of increased costs associated with the addition of the auxiliary processor.

The present disclosure has been devised in light of the above problems of the related art, and takes as an objective to provide an apparatus management device, a clock speed control method, and a program that realize increased power efficiency while also moderating costs, and in addition, are also able to prevent a drop in processing performance.

### Solution to Problem

In order to achieve the above objective, an apparatus management device according to the present disclosure is an apparatus management device, equipped with a processor, configured to manage apparatus connected via a communication network according to a process by the processor, the apparatus management device including:

learning means to learn a load period when a significant load is imposed on the processor, on the basis of a utilization condition of the processor; and

clock speed controlling means to control an operating clock speed of the processor so that the operating clock speed of the processor during a time period other than the load period is less than the operating clock speed of the processor during the load period.

### Advantageous Effects of Invention

According to the present disclosure, a load period when a load is imposed on the processor is learned, and the operating clock speed of the processor is controlled on the basis of the learning result. Consequently, increased power efficiency may be realized while also moderating costs, and in addition, a drop in processing performance may also be avoided.

### BRIEF DESCRIPTION OF DRAWINGS

FIG. 1 is a block diagram illustrating a configuration of an apparatus management device according to Embodiments 1 and 2 of the present disclosure;

FIG. 2 is a flowchart illustrating steps in a learning process of Embodiment 1;

FIG. 3 is a flowchart illustrating steps in a clock speed control process of Embodiment 1;

FIG. 4 is a diagram illustrating an example of results of a learning process and a clock speed control process of Embodiment 1; and

FIG. 5 is a diagram illustrating an example of results of a learning process and a clock speed control process of Embodiment 2.

### DESCRIPTION OF EMBODIMENTS

Hereinafter, exemplary embodiments of the present disclosure will be described in detail and with reference to the drawings. Note that in the drawings, identical or corresponding parts are denoted with identical signs.

### Embodiment 1

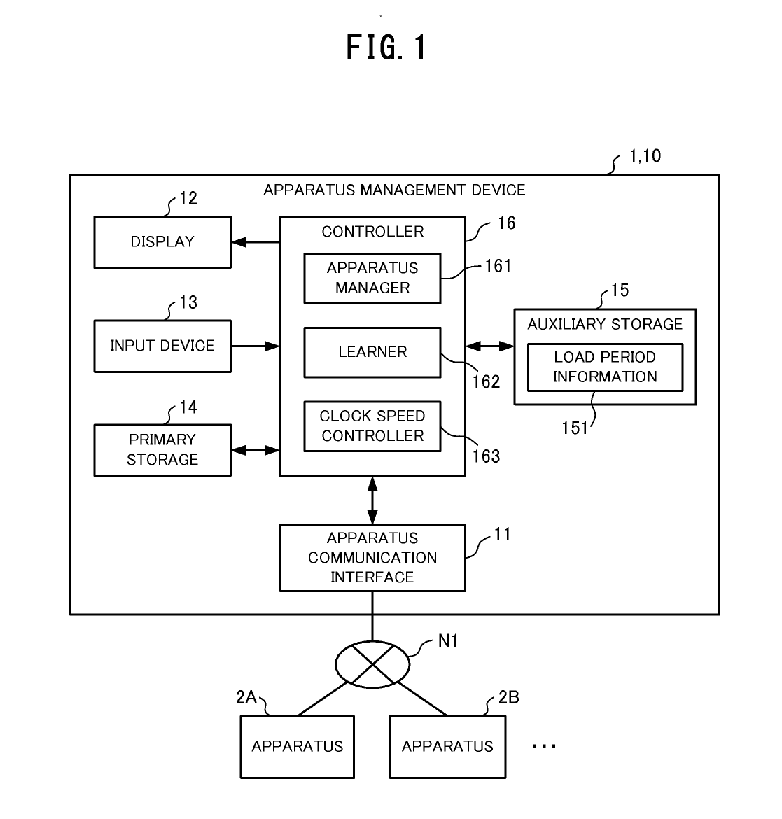

An apparatus management device 1 according to Embodiment 1 of the present disclosure will be described with reference to FIG. 1. The apparatus management device 1 monitors and controls respective apparatuses 2A, 2B, and so on, such as air conditioners and lighting equipment connected via a network N1. Note that the network N1 may be an air conditioning system network, a lighting system network, a home network conforming to ECHONET, or the like. Also, in the following description, the apparatuses 2A, 2B, and so on will be designated simply the apparatus 2 when not being individually distinguished.

As illustrated in FIG. 1, the apparatus management device 1 is equipped with an apparatus communication interface 11, a display 12, an input device 13, primary storage 14, auxiliary storage 15, and a controller 16.

The apparatus communication interface 11 is equipped with a designated communication interface. The apparatus communication interface 11, under control by the controller 16, communicates with each apparatus 2 via the network N1.

The display 12 is equipped with a liquid crystal display device or the like. The display 12, under control by the controller 16, displays a monitoring screen indicating the operational status and the like of each apparatus 2, and various screens for user operation. The input device 13 is equipped with a touch panel, touchpad, or the like. The input device 13 conducts a process of receiving operating input from the user.

The primary storage 14 is equipped with random access memory (RAM) or the like. The primary storage 14 acts as a work area for the execution of processing by the controller 16.

The auxiliary storage 15 is equipped with readable and writable non-volatile semiconductor memory, such as read-only memory (ROM) or flash memory, and a hard disk drive or the like. The auxiliary storage 15 stores programs executed by the controller 16, information indicating the operational status of each apparatus 2, and the like. In addition, the auxiliary storage 15 stores load period information 151, which indicates a load period when a significant load is imposed on the processor during a single day.

The controller 16 is equipped with a processor or the like, and controls the apparatus management device 1 overall. Note that the processor is configurable with two types of operating clock speeds: an operating clock speed comparable to the native performance of the processor (hereinafter, normal level clock speed), and an operating clock speed at a lower level than the normal operating clock speed (hereinafter, low level clock speed).

Functionally, the controller 16 is equipped with an apparatus manager 161, a learner 162, and a clock speed controller 163. The functions of these components are realized by the processor executing a program stored in the auxiliary storage 15.

The apparatus manager 161 controls the apparatus communication interface 11 to communicate with each apparatus 2, and monitors or controls each apparatus 2. For example, the apparatus manager 161 conducts a process of generating and transmitting to the apparatus 2 a control command for controlling the apparatus 2, either periodically or when there is a request from the user via the input device 13. In addition, the apparatus manager 161 conducts a process of receiving and storing in the auxiliary storage 15 information that indicates the status of the apparatus 2.

The learner 162 conducts a learning process of monitoring the utilization conditions of the processor, and learning a time period when the load on the processor increases during a single day. The learning process will be discussed in detail later.

The clock speed controller 163 controls the operating clock speed of the processor. Normally, the clock speed controller 163 sets the operating clock speed of the processor to the low level clock speed. On the other hand, during the load period, the clock speed controller 163 sets the operating clock speed of the processor to the normal level clock speed.

Next, operation of a process executed by the controller 16 of the apparatus management device 1 configured as above will be described.

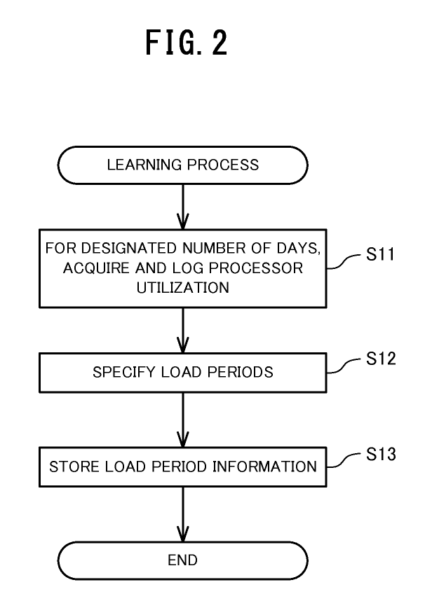

First, operation of the learning process executed by the learner 162 of the controller 16 will be described with reference to the flowchart in FIG. 2.

The user operates the input device 13 of the apparatus management device 1, and gives an instruction to start the learning process. Subsequently, the learner 162 acquires the processor utilization periodically (for example, every 1 minute) over a designated number of days (for example, 7 days), and logs the acquired utilization to a designated file in association with the time of acquisition (step S11). Note that the processor utilization may be acquired using a tool provided by the operating system (OS) of the apparatus management device 1, or by some other known method.

After the logging finishes for the designated number of days, the learner 162 specifies, on the basis of the log, a time period when a significant load is imposed on the processor (load period) (step S12). For example, if the processor is utilized at a utilization that is equal to or greater than a designated value (for example, equal to or greater than 60%) during the same time period on a majority of the logged days, the learner 162 may specify that time period as a load period. Alternatively, if the processor is utilized at a utilization that is equal to or greater than the average one-day utilization during the same time period on a majority of the logged days, the learner 162 may specify that time period as a load period.

Next, the learner 162 stores load period information 151 indicating a load period specified in step S12 in the auxiliary storage 15 (step S13). With that, the learning process ends.

Next, a clock speed control process executed by the clock speed controller 163 of the controller 16 will be described. At this point, suppose that the learning process discussed above has been executed, and suitable load period information 151 is being stored in the auxiliary storage 15.

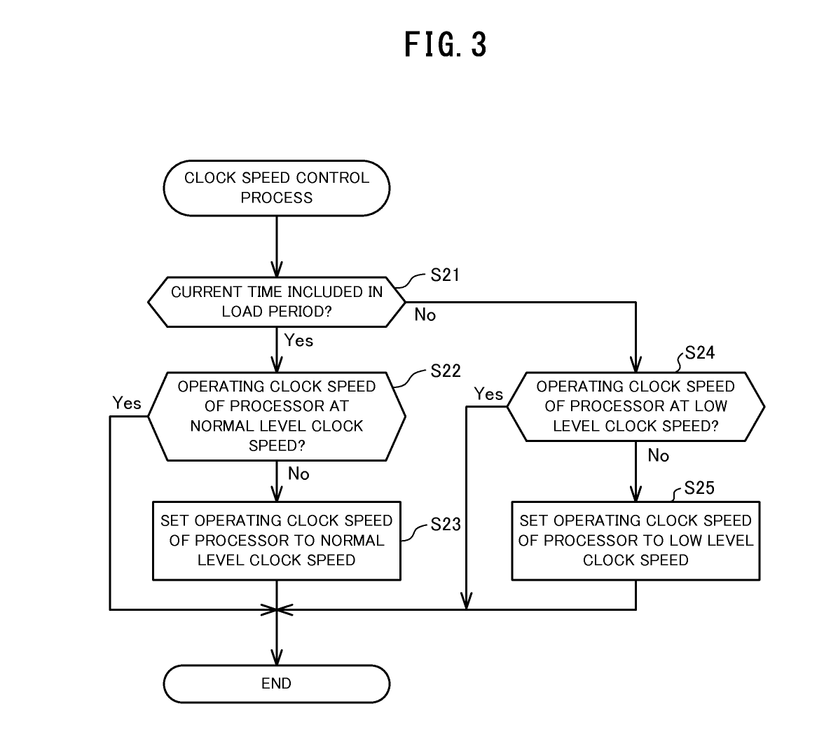

While the apparatus management device 1 is powered on, the clock speed controller 163 repeatedly executes the clock speed control process illustrated in the flowchart of FIG. 3 at a designated time interval (for example, every 1 minute).

First, the clock speed controller 163 determines whether or not the current time is included in a load period indicated by the load period information 151 (step S21).

If the current time is included in a load period (step S21; Yes), the clock speed controller 163 determines whether or not the currently set operating clock speed of the processor is the normal level clock speed (step S22).

If the operating clock speed of the processor is the normal level clock speed (step S22; Yes), the operating clock speed of the processor is appropriate, and the clock speed control process ends. On the other hand, if the currently set operating clock speed is not the normal level clock speed (step S22; No), the clock speed controller 163 sets the operating clock speed of the processor to the normal level clock speed (step S23), and the clock speed control process ends.

On the other hand, if the current time is not included in a load period (step S21; No), the clock speed controller 163 determines whether or not the currently set operating clock speed of the processor is the low level clock speed (step S24).

If the operating clock speed of the processor is the low level clock speed (step S24; Yes), the operating clock speed of the processor is appropriate, and the clock speed control process ends. On the other hand, if the currently set operating clock speed is not the low level clock speed (step S24; No), the clock speed controller 163 sets the operating clock speed of the processor to the low level clock speed (step S25), and the clock speed control process ends.

In this way, according to the clock speed control process, the operating clock speed of the processor is controlled to be the normal level clock speed during a load period, and the low level clock speed during a time period other than a load period. Note that the clock speed control process discussed above is merely one example, and that the operating clock speed of the processor may also be controlled using another method. For example, the clock speed controller 163 may use a known scheduling tool or the like to conduct clock speed control that switches the operating clock speed at the start time and the end time of a load period.

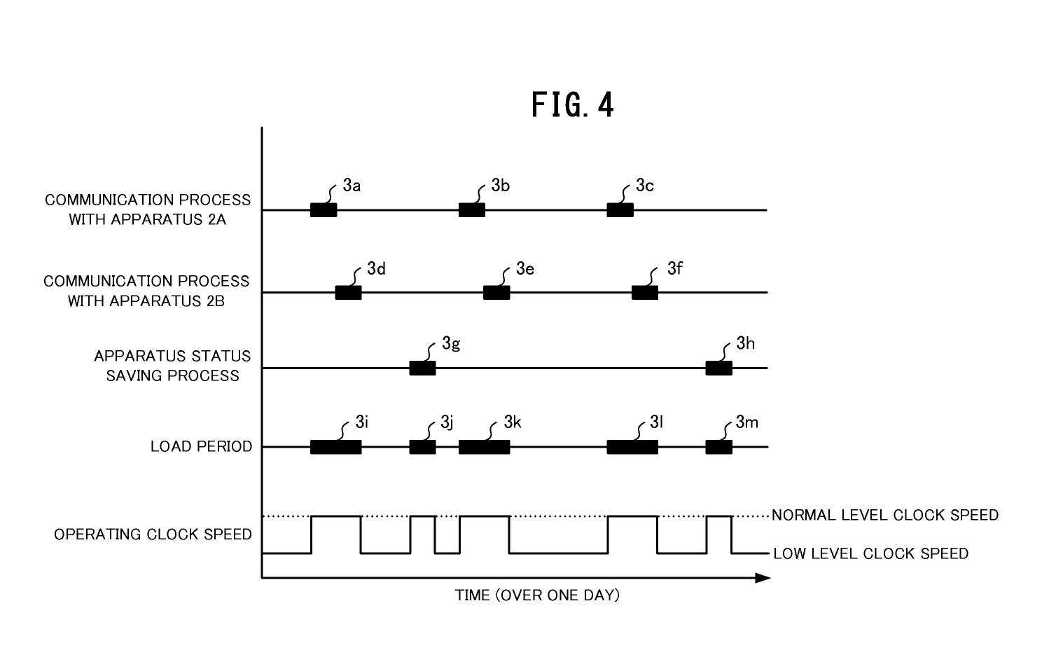

Next, the learning process and the clock speed control process discussed above will be described specifically with reference to FIG. 4. At this point, suppose that the apparatus 2 to be managed are only the apparatus 2A and 2B.

For example, at predetermined time periods during a single day, the apparatus manager 161 of the apparatus management device 1 conducts communication processes 3a to 3c with the apparatus 2A and communication processes 3d to 3f with the apparatus 2B, acquires the status of the apparatus 2A and 2B, and temporarily stores information indicating the status in the primary storage 14. Additionally, at predetermined time periods during a single day, the apparatus manager 161 conducts saving processes 3g and 3h, and stores in the auxiliary storage 15 information indicating the status of the apparatus 2A and 2B being stored temporarily in the primary storage 14 due to the communication processes. Typically, a comparatively significant load is imposed on the processor of the apparatus management device 1 while such communication processes and saving processes are executed.

After the learning process is executed in such a state, the load periods 3i to 3m are learned. Consequently, according to the clock speed control process, the operating clock speed of the processor is controlled to be the normal level clock speed during the load periods 3i to 3m, and the low level clock speed during other time periods.

As described above, according to the apparatus management device 1 in accordance with Embodiment 1, a load period when the load on the processor increases is learned on the basis of the processor utilization conditions. Specifically, in the case of an apparatus management device 1 that manages apparatus 2 such as air conditioners and lighting equipment, routinely scheduled processes are extremely numerous, and thus load periods may be learned easily and precisely. Additionally, the apparatus management device 1 controls the operating clock speed of the processor to be the normal level clock speed during the load periods, and the low level clock speed during all other time periods. Consequently, the processor may be operated at an optimal operating clock speed according to the load, without providing a separate auxiliary processor. As a result, increased power efficiency may be realized while also moderating costs, and in addition, a drop in processing performance may also be avoided.

Also, according to the apparatus management device 1 in accordance with Embodiment 1, since the operating clock speed of the processor is kept at the normal level during load periods, it is also possible to prevent a loss of user comfort as a result of the apparatus management device 1 being unable to sufficiently control air conditioners or other apparatus 2 due to a lack of processing performance

### Embodiment 2

Next, an apparatus management device 10 according to Embodiment 2 of the present disclosure will be described. In Embodiment 1, a processor that may be configured to the two types of operating clock speeds of a normal level clock speed and a low level clock speed is controlled so that the operating clock speed becomes the normal level clock speed during load periods, and the low level clock speed during all other time periods. In contrast, Embodiment 2 is characterized by conducting finer control of the operating clock speed of a processor that may be configured to a normal level clock speed and a the low level clock speed, as well as an additional clock speed at a higher level than the normal level clock speed (hereinafter, high level clock speed).

Note that, as illustrated in FIG. 1, the structural elements of the apparatus management device 10 according to Embodiment 2 are the same as the structural elements of the apparatus management device 1 according to Embodiment 1, and a description of each structural element will be reduced or omitted.

On the basis of the processor utilization, the learner 162 of the apparatus management device 10 determines, in addition to a load period, a high load period when a high load is imposed on the processor, and stores the determination result as load period information 151. For example, the learner 162 may determine a load period to be a time period when the processor is utilized at a utilization of 60% to 80% during the same time period on a majority of the logged days, and determine a high load period to be a time period when the process is utilized at a utilization of 80% or more.

In addition, the clock speed controller 163 of the apparatus management device 10 controls the operating clock speed of the processor to be the high level clock speed if the current time is included in the high load period, the normal level clock speed if the current time is included in the load period, and the low level clock speed for all other time periods.

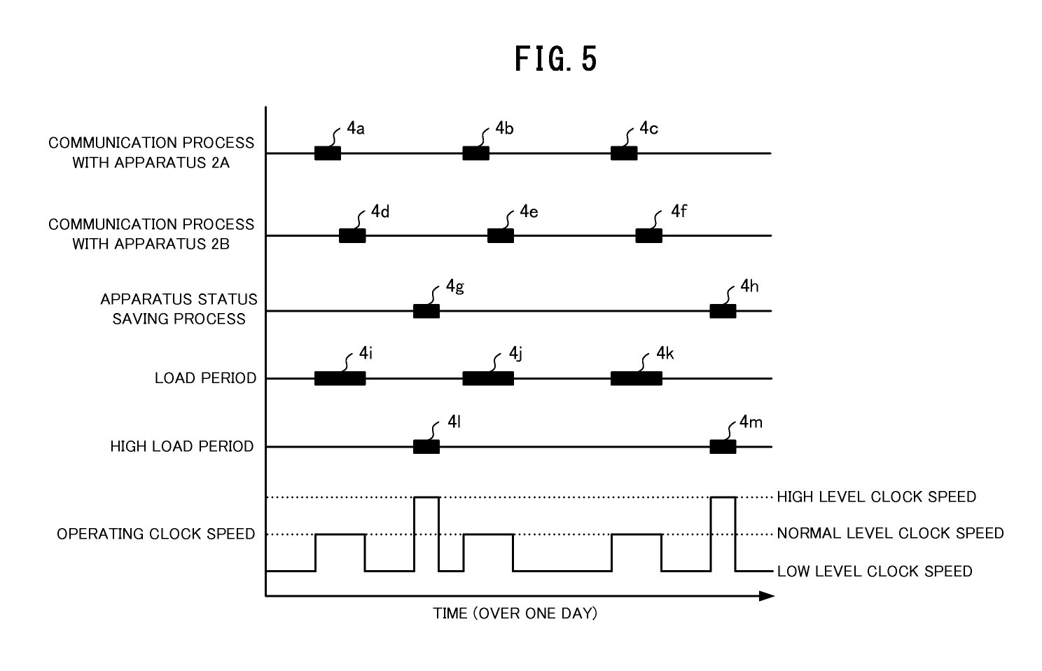

Next, the learning process and the clock speed control process executed by the learner 162 and the clock speed controller 163 will be described specifically with reference to FIG. 5. At this point, suppose that the apparatus 2 to be managed are only the apparatus 2A and the apparatus 2B.

In FIG. 5, similarly to FIG. 4, suppose that a significant load is imposed on the processor of the apparatus management device 10 during communication processes 4a to 4f and saving processes 4g and 4h, but the processor load is greater for the saving processes 4g and 4h.

After the learning process is executed in such a state, the load periods 4i to 4k and the high load periods 4l and 4m are learned. Consequently, as illustrated in FIG. 5, according to the clock speed control process, the operating clock speed of the processor is controlled to be the normal level clock speed during the load periods 4i to 4k, the high level clock speed during the load-periods 4l and 4m, and the low level clock speed during other time periods.

As described above, according to the apparatus management device 10 in accordance with Embodiment 2, since finer control of the operating clock speed of the processor may be conducted according to the load level, it is possible to operate the processor at a more optimal operating clock speed.

Note that Embodiment 2 describes a learning process and a clock speed control process conducted on a processor configurable with the three types of operating clock speed of a high level clock speed, a normal level clock speed, and a low level clock speed. However, the present disclosure is also applicable to a processor configurable with more operating clock speeds. In this case, multiple stages of load periods may be learned according to the level of the magnitude of the processor load, and the operating clock speed may be controlled according to the learned load period for each stage.

Note that the present disclosure is not limited to the foregoing exemplary embodiments, and that various modifications are obviously possible within a scope that does not depart from the spirit of the present disclosure.

For example, in the clock speed control process of the foregoing embodiments, the clock speed controller 163 controls the operating clock speed of the processor to be the low level clock speed when the current time is not a load period or a high load period. However, even if the current time is not a load period or a high load period, when there is a designated instruction from the user via the input device 13, the clock speed controller 163 may control the operating clock speed of the processor to be the normal level clock speed or the high level clock speed.

Also, the apparatus 2 such as air conditioners and lighting equipment typically have different usage conditions depending on the attributes of the day (such as the day of the week, month, season, and whether the day is a weekday or a weekend), and in many cases the processor load periods are also correspondingly different. Consequently, the learner 162 may also execute a learning process and learn load periods for respective attributes of the day.

For example, the learner 162 may conduct a learning process for each day of the week. Specifically, the learner 162 determines load periods for each day of the week from the log of processor utilization conditions for each day of the week over the last four weeks, and stores load period information 151 for each day of the week. Subsequently, the clock speed controller 163 may use the load period information 151 corresponding to the current day of the week (the day of executing control) to execute the clock speed control process.

As another example, the learner 162 may also conduct the learning process separately on weekdays (Monday to Friday) and weekends (Saturday and Sunday). In other words, the learner 162 determines load periods on the basis of the processor utilization conditions on weekdays over the last four weeks, and stores weekday load period information 151. Additionally, the learner determines load periods on the basis of the processor utilization conditions on weekends over the last four weeks, and stores weekend load period information 151. Subsequently, the clock speed controller 163 may execute the operating clock speed process by using the weekday load period information 151 if the current day (the day of executing control) is a weekday, and using the weekend load period information 151 if the current day is a weekend.

Also, in the foregoing embodiments, the learning processor is started when there is an instruction from the user, and the learner 162 logs the processor utilization conditions for a designated number of days (for example, 7 days), and determines load periods from the log. However, the learner 162 may also continuously log the processor utilization conditions while the apparatus management device 1 or 10 is powered on, and once each day (or at a designated interval), determine load periods from the log of processor utilization conditions for a designated number of recent days, and update the load period information 151. In so doing, the load periods reflect recent processor utilization conditions, and more precise control of the operating clock speed of the processor becomes possible.

In addition, in the learning process of the foregoing embodiments, a determination of whether or not there is a load period is made on the basis of processor utilization. However, the determination of whether or not there is a load period may also be made on the basis of information indicating another utilization condition of the processor. For example, the determination of whether or not there is a load period may also be made on the basis of a processor temperature value.

In addition, in the foregoing embodiments, by applying a program respectively executed by the apparatus management device 1 or 10 to an existing personal computer (PC) or the like, it is possible to cause the PC or the like to function as the apparatus management device 1 or 10 according to the present disclosure.

The method of distributing such a program is arbitrary, and the program may be stored and distributed on a non-transitory computer-readable recording medium such as a Compact Disc-Read-Only Memory (CD-ROM), a Digital Versatile Disc (DVD), a magneto-optical (MO) disc, or a memory card, and may also be distributed via a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure may be suitably adopted in a device that manages apparatus inside a building.

### REFERENCE SIGNS LIST

1, 10 Apparatus management device
11 Apparatus communication interface
12 Display
13 Input device
14 Primary storage
15 Auxiliary storage
151 Load period information
16 Controller
161 Apparatus manager
162 Learner
163 Clock speed controller
2A, 2B Apparatus
N1 Network

1. An apparatus management device, equipped with a processor, configured to manage apparatus connected via a communication network according to a process by the processor, the apparatus management device comprising:
a learner configured to learn, for attributes of a day, a load period when a significant load is imposed on the processor, from a utilization condition of the processor on a day having each attribute; and
a clock speed controller configured to control an operating clock speed of the processor so that the operating clock speed of the processor during a time period other than the load period corresponding to an attribute of a current day is less than the operating clock speed of the processor during the load period corresponding to the attribute of the current day.

2. The apparatus management device according to claim 1, wherein
the learner learns the load period in a plurality of stages, on the basis of a level of magnitude of load imposed on the processor, and
the clock speed controller controls the operating clock speed of the processor to be an operating clock speed corresponding to a load period in each stage.

3. The apparatus management device according to claim 1, wherein
the learner learns the load period on the basis of a utilization of the processor.

4. (canceled)

5. A clock speed control method for controlling an operating clock speed of a processor, the method comprising:
learning, for attributes of a day, a load period when a significant load is imposed on the processor, from a utilization condition of the processor on a day having each attribute; and
controlling an operating clock speed of the processor so that the operating clock speed of the processor during a time period other than the load period corresponding to an attribute of a current day is less than the operating clock speed of the processor during the load period corresponding to the attribute of the current day.

6. A non-transitory computer-readable recording medium storing a program, the program causing a computer equipped with a processor for managing apparatus connected via a communication network according to a process by the processor to function as:
a learner configured to learn, for attributes of a day, a load period when a significant load is imposed on the processor, from a utilization condition of the processor on a day having each attribute; and
a clock speed controller configured to control an operating clock speed of the processor so that the operating clock speed of the processor during a time period other than the load period corresponding to an attribute of a current day is less than the operating clock speed of the processor during the load period corresponding to the attribute of the current day.

7. The apparatus management device according to claim 1, wherein
the learner learns the load period for a weekday and the load period for a weekend from the utilization condition of the processor on the weekday and the utilization condition of the processor on the weekend, respectively.
